(19) United States
(12) Patent Application Publication
(10) Pub. No.: US 2020/0358181 A1
(43) Pub. Date: Nov. 12, 2020

(54) ANTENNA SYSTEM WITH RECONFIGURABLE TWO-DIMENSIONAL RADIATION PATTERN

(71) Applicants: Jiangsu Hengxin Technology Co., Ltd, Yixing City (CN); Jiangsu Hengxin Wireless Technology Co., Ltd, Yixing City (CN)

(72) Inventors: YanPing HUA, Yixing City (CN); LingYun Chen, Yixing City (CN); ShunQing Zhang, Yixing City (CN); JiongSai Zhou, Yixing City (CN); CongGuang Zhao, Yixing City (CN); Tao Zhou, Yixing City (CN)

(21) Appl. No.: 16/474,859

(22) PCT Filed: Aug. 27, 2018
(86) PCT No.: PCT/CN2018/102433

§ 371 Date: Jun. 28, 2019

(30) Foreign Application Priority Data
Jan. 1, 2018 (CN) 201810026047.3

(51) Int. Cl. H01Q 3/28; H01Q 3/30; H01Q 21/06; H01Q 3/26

(52) U.S. Cl. CPC H01Q 3/28; H01Q 3/2617; H01Q 21/06; H01Q 3/30

(57) ABSTRACT

An antenna system with a reconfigurable two-dimensional radiation pattern comprises an antenna vibrator array module for transmitting and receiving signals; a Butler matrix module for forming horizontal and perpendicular wave beam characteristics before the antenna vibrator array module transmits signals, which is composed of a 3 dB bridge; a phase shifter module for transmitting input signals provided by a feed network or a transceiver and providing the input signals to the Butler matrix module, which comprises at least one phase shifter with equal power distribution. The phase shifter module has one input port and four output ports, the Butler matrix module has multiple input ports and multiple output ports, the four output ports of the phase shifter module are respectively connected with a corresponding one of the input ports of the Butler matrix module, and the output ports of the Butler matrix module are connected with the antenna vibrator array module.

### CROSS REFERENCE TO RELATED APPLICATIONS

This application is a national stage application under 35 U.S.C. 371 of PCT Application No. PCT/CN2018/102433, filed on 27 Aug. 2018, which PCT application claimed the benefit of Chinese Patent Application No. 2018100260473, filed on 1 Jan. 2018, the entire disclosure of each of which are hereby incorporated herein by reference.

### FIELD

The disclosure relates to the technical field of wireless communication, and particularly, to an antenna system with a reconfigurable two-dimensional radiation pattern.

### BACKGROUND

Each antenna controls a certain area in wireless communication coverage, which is called a sector or a cell, and in this area, the antenna receives and radiates electromagnetic waves, controls a radiation radius by controlling a downtilt of a lobe, and determines a sector coverage area of the cell by setting a horizontal beam width.

There are many ways to adjust the downtilt of the antenna, such as mechanical downtilt and electrical downtilt, and relatively speaking, the technology development is relatively mature. However, considering the sector coverage areas of different cells, the antenna needs to make corresponding adjustments in index parameters such as the horizontal beam width, and the existing traditional antenna beam width is fixed. Considering that new antennas need to be re-developed and designed in different application environments to meet index requirements, the costs in research and development are increased and the wastes of antenna material resources are generated.

Therefore, it is urgent to devise a method that the beam width is adjustable to solve the problem, reduce the costs in research and development, and increase the applicability of the antenna.

### SUMMARY

The disclosure is intended to provide an antenna system with a reconfigurable two-dimensional radiation pattern, which is adjustable in wave beam width, simple in structure and easy to realize.

In order to solve the technical problems above, the technical solutions of the disclosure are as follows.

An antenna system with a reconfigurable two-dimensional radiation pattern comprises:

an antenna vibrator array module for transmitting and receiving signals, which is composed of a plurality of dual-polarized vibrators with equal spacing of ±45°;

a Butler matrix module for forming horizontal and perpendicular wave beam characteristics before the antenna vibrator array module transmits signals, which is composed of a 3 dB bridge; and

a phase shifter module for transmitting input signals provided by a feed network or a transceiver and providing the input signals to the Butler matrix module, which comprises at least one phase shifter with equal power distribution;

wherein, the phase shifter module has one input port and four output ports, the Butler matrix module has multiple input ports and multiple output ports, the four output ports of the phase shifter module are respectively connected with a corresponding one of the input ports of the Butler matrix module, and the output ports of the Butler matrix module are connected with the antenna vibrator array module.

Preferably, the phase shifter is a mirror phase shifter.

Preferably, the antenna vibrator array module comprises four dual-polarized vibrators with equal spacing of ±45°, and a spacing between adjacent vibrators is 105 mm.

Preferably, the 3 dB bridge is a 90-degree 3 dB bridge.

By using the technical solutions above, the disclosure at least comprises the following beneficial effects.

According to the antenna system with a reconfigurable two-dimensional radiation pattern disclosed by the disclosure, adjustable and controllable amplitude distribution of the signals is realized by the Multiple-Input Multiple-Output Butler matrix, so as to realize continuously adjustable horizontal or perpendicular wave beam width of the antenna.

### BRIEF DESCRIPTION OF THE DRAWINGS

FIG. 1 is a schematic block diagram of an antenna system according to an embodiment of the disclosure;

FIG. 2 is a stereoscopic diagram of the antenna system according to the embodiment of the disclosure;

FIG. 3 is a working principle diagram of the antenna system according to the embodiment of the disclosure;

FIG. 4 is a simulation diagram of a radiation pattern of an antenna system with a phase difference of 5°;

FIG. 5 is a simulation diagram of a radiation pattern of an antenna system with a phase difference of 20°, and

FIG. 6 is a simulation diagram of a radiation pattern of an antenna system with a phase difference of 45°.

In the figures: 11 refers to phase shifter module, 12 refers to Butler matrix module, and 13 refers to antenna vibrator array module.

### DETAILED DESCRIPTION OF THE EMBODIMENTS

The technical solutions in the embodiments of the disclosure are clearly and completely described below with reference to the drawings in the embodiments of the disclosure, and obviously, the described embodiments are merely a part of embodiments of the disclosure instead of all embodiments. Based on the embodiments in the disclosure, all other embodiments obtained by those of ordinary skills in the art without creative works shall fall within the protection scope of the disclosure.

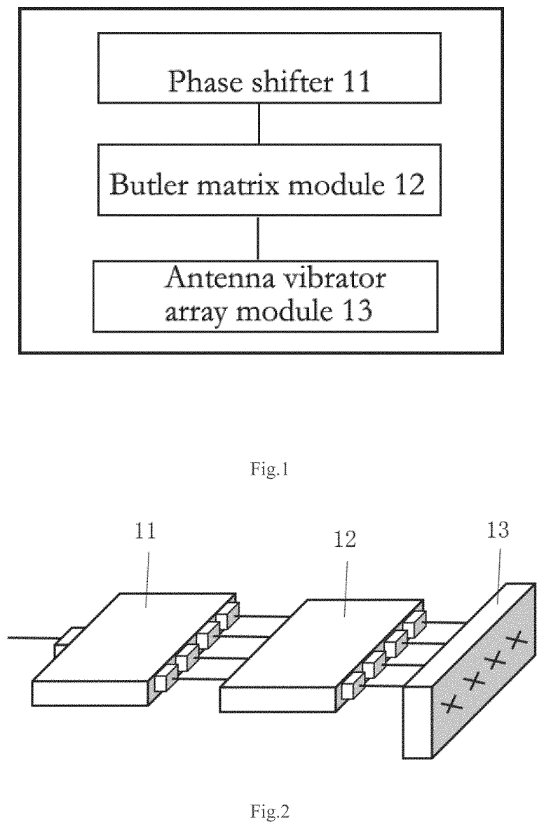

As shown in FIG. 1 to FIG. 3, an antenna system with a reconfigurable two-dimensional radiation pattern according to the disclosure comprises:

an antenna vibrator array module 13 for transmitting and receiving signals, which is composed of a plurality of dual-polarized vibrators with equal spacing of ±45°;

a Butler matrix module 12 for forming horizontal and perpendicular wave beam characteristics before the antenna vibrator array module 13 transmits signals, which is composed of a 3 dB bridge; and

a phase shifter module 11 for transmitting input signals provided by a feed network or a transceiver and providing the input signals to the Butler matrix module 12, which comprises at least one phase shifter with equal power distribution;

wherein, the phase shifter module 11 has one input port and four output ports, the Butler matrix module 12 has multiple input ports and multiple output ports, the four output ports of the phase shifter module 11 are respectively connected with a corresponding one of input ports of the Butler matrix module 12, and the output ports of the Butler matrix module 12 are connected with the antenna vibrator array module 13.

The modules described in the solutions above are merely main modules required by the antenna system, and may further comprise a feed network module for adjusting a downtilt of an antenna lobe and a horizontal azimuth angle. According to the disclosure, the downtilt of the signal and the horizontal azimuth angle can be adjusted by combining with the feed network module, thus improving the applicability of the antenna to the environment, saving the research and development costs and the material resources of the antenna, having a simple system structure, and being easy to remotely control and optimize the antenna in real time.

Corresponding numbers of the bridges and the vibrators in the antenna Butler matrix module 12 and the antenna vibrator array module 13 above are not limited to the numbers in the embodiment of the disclosure, but also have certain expansibility.

Preferably, the phase shifter is a mirror phase shifter.

Preferably, the antenna vibrator array module 13 comprises four dual-polarized vibrators with equal spacing of ±45°, and a spacing between adjacent vibrators is 105 mm.

Preferably, the 3 dB bridge is a 90-degree 3 dB bridge.

In a preferred embodiment, taking a Four-In Four-Out Butler matrix as an example, the system comprises the phase shifter module 11, the Butler matrix module 12 and the antenna vibrator array module 13, the output signals of the system feed network or the transceiver enter a Four-Out mirror phase shifter module 11, and then the signals outputted by the phase shifter are inputted into the Butler matrix module 12 formed by the 90-degree 3 dB bridge. The signals outputted by the Butler matrix feed the antenna vibrator array, the signals transmitted by the antenna vibrator array are combined into an antenna lobe pattern, and by adjusting the phase shifter, the phase of the signals inputted to the Butler matrix is changed, thus affecting power of the output signals of the Butler matrix. On the premise of ensuring the requirement of a sidelobe index, the antenna vibrators are fed with different powers, so that the beam width of the antenna may be continuously adjusted within a certain angle range.

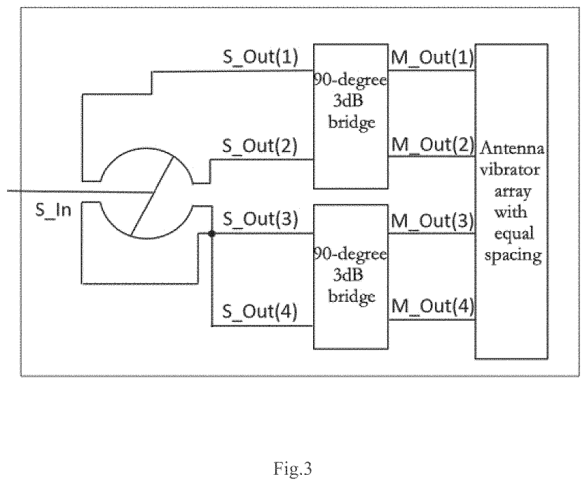

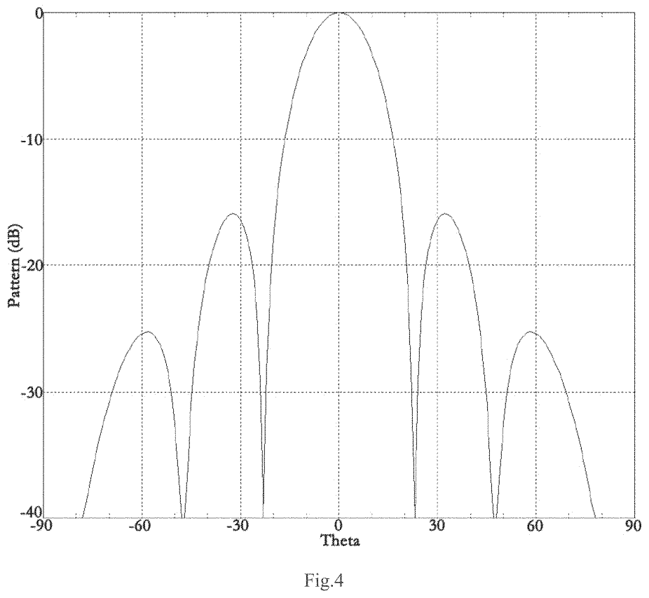

FIG. 3 illustrates a working principle of the antenna system according to the embodiment of the disclosure, the input signal is represented by S_In, the output signals of four ports of the mirror phase shifter are respectively represented by S_Out(1), S_Out(2), S_Out(3) and S_Out(4), the output signals of four ports of the Butler matrix module 12 are respectively represented by M_Out(1), M_Out(2), M_Out(3) and M_Out(4), and a shifted phase of the phase shifter is represented by Delta_Phz. A phase difference of S_Out(1) and S_Out(2) is easily obtained according to FIG. 3 as 2*Delta_Phz. Similarly, a phase difference of S_Out(4) and S_Out(3) is also 2*Delta_Phz. The input signals pass through the mirror phase shifter of equal power distribution to obtain output signals of the phase shifter with equal power, the phases of the output signals are determined by the phase shifter, the output signals of the phase shifter with equal phase difference are inputted to two input ports of the 90-degree 3 dB bridge, the output signals of the Butler matrix may be obtained according to a Butler matrix principle, the output signals of different power distributions may be obtained according to different phase differences, and the phase differences of the output signals of the Butler matrix of this structure may be known to be equal according to the working principle of the Butler matrix. The signals of different power distributions outputted by the Butler matrix feed the antenna vibrator array, and the beam width of the antenna may be adjusted. Since the phase shifter may continuously adjust the phase, the output signals of the phase shifter may also have a continuous phase difference, and the amplitude of the output signals of the Butler matrix may have a continuous adjustment process. In this case, continuous beam width adjustment may be obtained by feeding the array vibrator.

Table 1 below illustrates some typical data statistics of the phase difference of the input signals, the output signals of the phase shifter, and the amplitude and the phase of the output signals of the Butler matrix under different shifted phases of the phase shifter, wherein Phz_Out represents an output phase of the phase shifter, Amp_M_Out represents an output amplitude of the Butler matrix, and Phz_M_Out represents an output phase of the Butler matrix. It can be known that when the phase difference of the phase shifter is 45°, 1-channel and 4-channel output amplitude values of the output signals of the Butler matrix may be zero, and only two vibrators at middle play a role at the moment to realize the maximum value of the beam width under this model condition.

TABLE 1
Output Signal Statistics of Phase Shifter and Butler Matrix

| | | | | |
|---|---|---|---|---|
| Delta_Phz (°) | 5 | 10 | 20 | 45 |
| Phz_Out (1)(°) | −5 | −10 | −20 | −45 |
| Phz_Out (2)(°) | 5 | 10 | 20 | −45 |
| Phz_Out (3)(°) | 5 | 10 | 20 | −45 |
| Phz_Out (4)(°) | −5 | −10 | −20 | −45 |
| Amp_M_Out (1) | 1.29 | 1.15 | 0.85 | 0 |
| Amp_M_Out (2) | 1.53 | 1.64 | 1.81 | 2 |
| Amp_M_Out (3) | 1.53 | 1.64 | 1.81 | 2 |
| Amp_M_Out (4) | 1.29 | 1.15 | 0.85 | 0 |
| Phz_M_Out (1)(°) | −45 | −45 | −45 | −45 |
| Phz_M_Out (2)(°) | −45 | −45 | −45 | −45 |
| Phz_M_Out (3)(°) | −45 | −45 | −45 | −45 |
| Phz_M_Out (4)(°) | −45 | −45 | −45 | −45 |

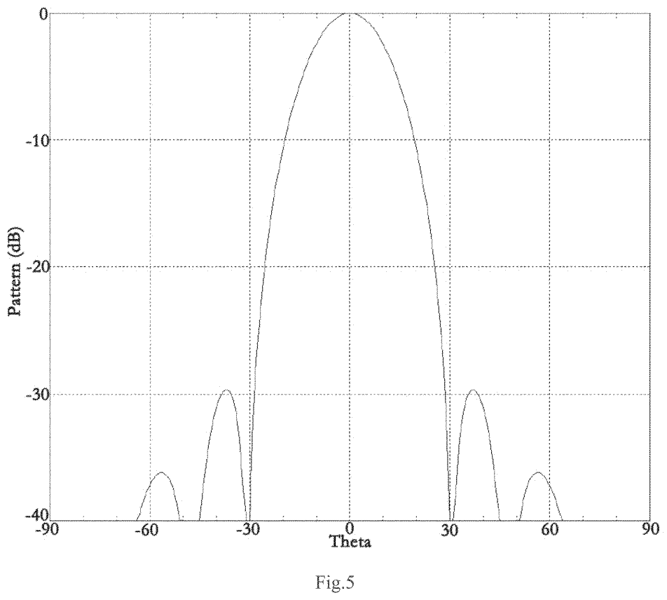

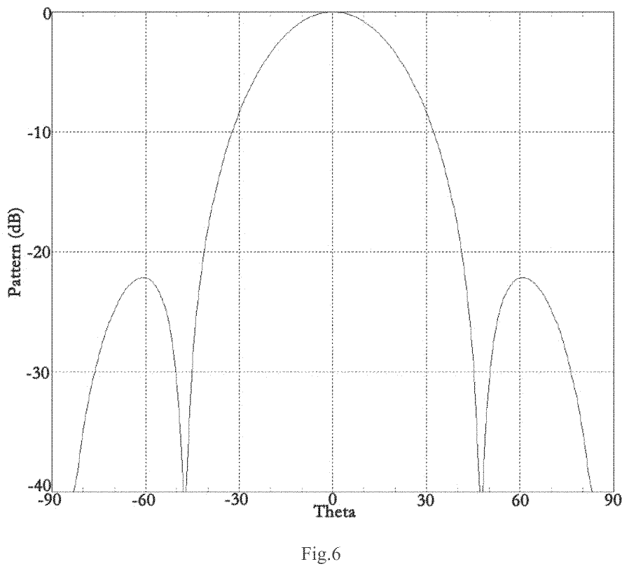

Taking 1710 to 2170 MHz frequency band as an example, four dual-polarized vibrators with equal spacing of ±45° are used, a spacing between adjacent vibrators is set as 105 mm, the pattern of the array radiation signals may be obtained through simulation, and as shown in FIG. 4 to FIG. 6, Table 2 below illustrates specific numerical statistics of wave width and sidelobe suppression of the radiation pattern corresponding to Table 1. The simulation may realize the change in the angle range of 20° to 37.5°, and the horizontal beam width adjustment may be further expanded by adjusting the environment condition of an intermediate radiation unit, such as adjusting a height of a reflecting plate or a baffle, increasing or decreasing the spacing between adjacent vibrators, etc. Meanwhile, the same structure set in the perpendicular direction of the antenna may also realize the adjustment of the beam width in the perpendicular direction of the antenna.

The horizontal azimuth angle of the antenna and the downtilt of the lobe may be adjusted by adding the phase shifter at a place where the signals are outputted by the Butler matrix, so as to adjust the output phase of the signals and realize the adjustment of the horizontal azimuth angle of the antenna and the downtilt of the lobe, thus realizing the adjustment of the two-dimensional pattern of the antenna system.

TABLE 2
Wave Width and Lobe Statistics of Antenna Radiation Pattern

| | | | | |
|---|---|---|---|---|
| Horizontal | 19.40 | 20.58 | 22.25 | 37.54 |
| plane wave | | | | |
| width (°) | | | | |
| Lobe (dB) | 16 | 19 | 29.6 | 22.1 |

To sum up, the disclosure may realize the adjustment of the horizontal beam width of the antenna system, and the reception of signals by the antenna is an inverse process of the transmission of signals with the same principle, which is not repeated here. The phase difference of the mirror phase shifter is skillfully utilized, so that the output signals of the Butler matrix have equal phases, without needing additional cable phase compensation, which has simple structure and is easy to realize.

The foregoing description of the disclosed embodiments enables those skilled in the art to achieve or use the disclosure. The various modifications to these embodiments will be apparent to those skilled in the art, and the general principles defined herein may be implemented in other embodiments without departing from the principle or scope of the disclosure. Therefore, the disclosure will not be limited to these embodiments shown herein, and shall have a broadest scope consistent with the principles and novel features disclosed herein.

1. An antenna system with a reconfigurable two-dimensional radiation pattern, comprising:
an antenna vibrator array module for transmitting and receiving signals, which is composed of a plurality of dual-polarized vibrators with equal spacing of ±45°;
a Butler matrix module for forming horizontal and perpendicular wave beam characteristics before the antenna vibrator array module transmits signals, which is composed of a 3 dB bridge; and
a phase shifter module for transmitting input signals provided by a feed network or a transceiver and for providing the input signals to the Butler matrix module, which comprises at least one phase shifter with equal power distribution;
wherein, the phase shifter module has one input port and four output ports, the Butler matrix module has multiple input ports and multiple output ports, the four output ports of the phase shifter module are respectively connected with a corresponding one of the input ports of the Butler matrix module, and the output ports of the Butler matrix module are connected with the antenna vibrator array module.

2. The antenna system with a reconfigurable two-dimensional radiation pattern as claimed in claim 1, wherein the phase shifter is a mirror phase shifter.

3. The antenna system with a reconfigurable two-dimensional radiation pattern as claimed in claim 1, wherein the antenna vibrator array module comprises four dual-polarized vibrators with equal spacing of ±45°, and a spacing between adjacent vibrators is 105 mm.

4. The antenna system with a reconfigurable two-dimensional radiation pattern as claimed in claim 1, wherein the 3 dB bridge is a 90-degree 3 dB bridge.
